(19) United States
(12) Patent Application Publication
(10) Pub. No.: US 2025/0013352 A1
(43) Pub. Date: Jan. 9, 2025

(54) CONTEXTUALIZED TERMINOLOGY REPLACEMENT

(71) Applicant: International Business Machines Corporation, Armonk, NY (US)

(72) Inventors: Dan Matthew Elkins, Southaven, MS (US); Jason Spight, Sandy Springs, GA (US); Mark William Harris, Bartlett, TN (US); Zachary A. Silverstein, Austin, TX (US)

(21) Appl. No.: 18/219,002

(22) Filed: Jul. 6, 2023

(51) Int. Cl. G06F 3/0483; G06F 3/0484; G06F 3/16; G06T 11/00; G10L 15/18

(52) U.S. Cl. CPC G06F 3/0483; G06F 3/0484; G06F 3/167; G06T 11/00; G10L 15/18; G06F 2203/04803; G10L 2015/088

(57) ABSTRACT

An example operation may include one or more of receiving a natural language input submitted from a meeting device, identifying a name of an object based on the natural language input, mapping the name of the object to a name of an alternative object, and identifying a web page corresponding to the alternative object via a rule set, and displaying an option to navigate to the identified web page corresponding to the alternative object via a user interface displayed on the user device.

### BACKGROUND

The terminology that is used to describe products, everyday items, software, etc., can be highly specific to the individual that is using them. For example, different generations, different cultures, different geographies, etc., may use different terminology to describe the same items. When a user searches for an object on the web they may be limited in their terminology with respect to that subject. For example, a user may be aware of a software product that is available for a particular process but may not be aware of a name of a similar software product that is available with a different vendor.

### SUMMARY

One example embodiment provides an apparatus that includes a processor that may perform one or more of receive a natural language input submitted from a user device, identify a name of an object based on the natural language input, map the name of the object to a name of an alternative object and identify a web page corresponding to the alternative object via a rule set, and display an option to navigate to the identified web page that corresponds to the alternative object via a user interface displayed on the user device.

Another example embodiment provides a method that includes one or more of receiving a natural language input submitted from a user device, identifying a name of an object based on the natural language input, mapping the name of the object to a name of an alternative object and identifying a web page corresponding to the alternative object via a rule set, and displaying an option to navigate to the identified web page corresponding to the alternative object via a user interface displayed on the user device.

A further example embodiment provides a computer program product comprising a computer readable storage medium having stored thereon instructions, that when executed by a processor, cause the processor to perform one or more of receiving a natural language input submitted from a user device, identifying a name of an object based on the natural language input, mapping the name of the object to a name of an alternative object and identifying a web page corresponding to the alternative object via a rule set, and displaying an option to navigate to the identified web page corresponding to the alternative object via a user interface displayed on the user device.

### BRIEF DESCRIPTION OF THE DRAWINGS

FIG. 1 depicts a computing environment, according to example embodiments.

FIGS. 2A-2D are diagrams illustrating processes for recommending additional content based on contextual alternatives according to example embodiments.

FIGS. 3A-3D are diagrams illustrating processes for training and executing a machine learning model according to example embodiments.

FIG. 4A is a diagram illustrating a method of generating and displaying an option for alternative content according to example embodiments.

FIG. 4B is a diagram illustrating a method of generating and displaying an option for alternative content according to other example embodiments.

### DETAILED DESCRIPTION

It is to be understood that although this disclosure includes a detailed description of cloud computing, implementation of the teachings recited herein is not limited to a cloud computing environment. Rather, embodiments of the instant solution are capable of being implemented in conjunction with any other type of computing environment now known or later developed.

The example embodiments are directed to a system that can identify context from a block of text/speech, such as text included in a web page, a teleconference, a document, and the like, which is associated with an object. The system may be an application or other software program hosted on a platform such as a cloud platform, web server, or the like. The object, in some examples, may refer to a product, including tangible products for everyday goods as well as products for other items such as software, clothing, automobiles, services, etc. The system can detect that the user is interested in such an object based on the access pattern of the user in their browser, the browsing history of the user, other users with similar interests, and the like. The system can then identify an alternative object that is similar to the object, but which may not be known to the user, and display a prompt on the browser/user interface which includes a link to a web page that is related to the alternative object, such as a sales page on a different website. The prompt may include a navigation button or other selectable option which the user can select, causing the browser/user interface to navigate to the corresponding web page that is related to the alternative object.

In some embodiments, the alternative object that is recommended by a host system may be an object that the user has not visited before within the browsing history. As another example, the alternative object that is recommended by the host system may be an object that the user has already visited before, and possibly just forgot about. The triggering mechanism for the host system to provide such an alternative object recommendation may be the opening of the web page that describes the object, or when a name of the object is detected from a meeting that is being recorded. The name may be identified via a machine learning service that includes a natural language processing (NLP) model(s) that enables a computing system to interpret input audio and identify text/words from the audio just as a human would.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or data center).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based email). The consumer does not manage or control the underlying cloud infrastructure, including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure, including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community with shared concerns (e.g., mission, security requirements, policy, and compliance considerations). It may be managed by organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service-oriented with a focus on statelessness, low coupling, modularity, and semantic interoperability. At the heart of cloud computing is an infrastructure that includes a network of interconnected nodes.

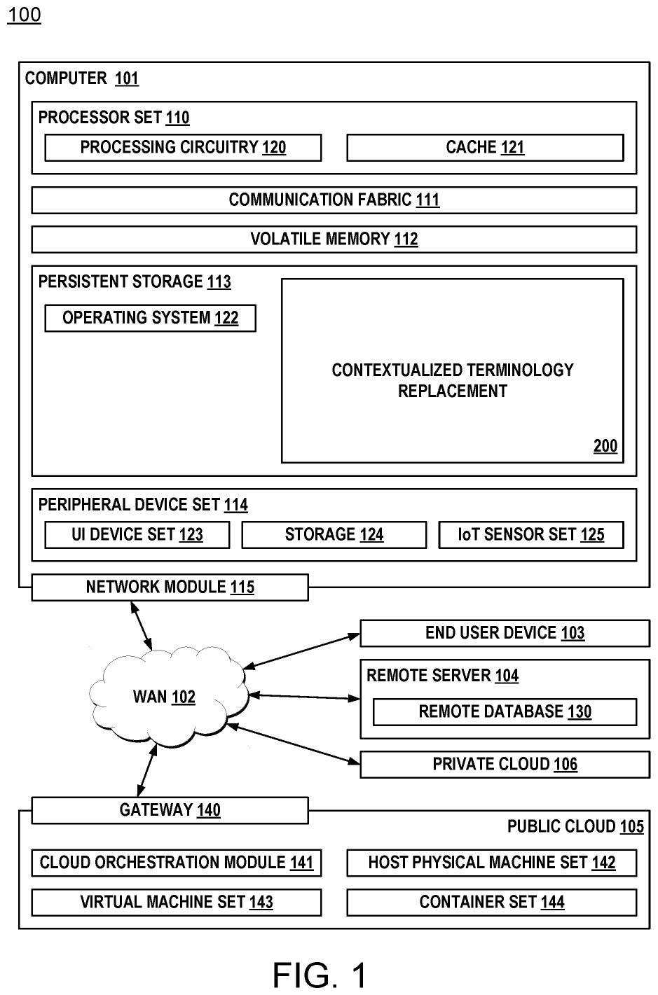

Referring now to FIG. 1, a computing environment 100 is depicted. Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart.

For example, again, depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for executing at least some of the computer code involved in performing the inventive methods, such as contextualized terminology replacement 200. In addition to block 200, computing environment 100 includes, for example, computer 101, wide area network (WAN) 102, end-user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smartphone, smartwatch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, the performance of a computer-implemented method may be distributed among multiple computers and/or between multiple locations. On the other hand, in this presentation of the computing environment 100, a detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is a memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off-chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby affect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric comprises switches and electrically conductive paths, such as the switches and electrically conductive paths that make up buses, bridges, physical input/output ports, and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read-only memory (ROM), but typically at least a portion of the persistent storage allows writing of data, deletion of data, and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smartwatches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer, and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, this data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanations of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as communicating with WAN 102, in other embodiments, a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both parts of a larger hybrid cloud.

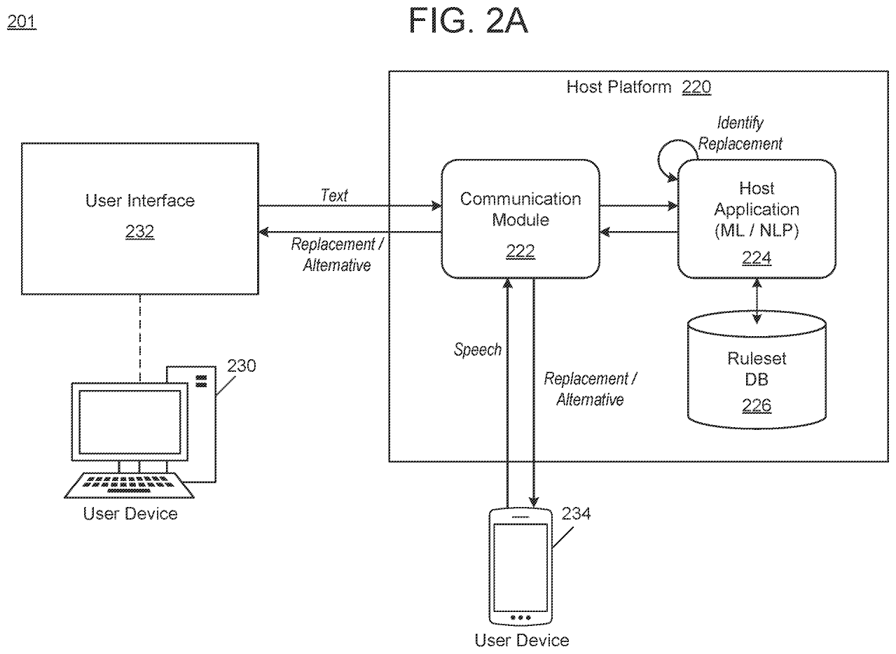

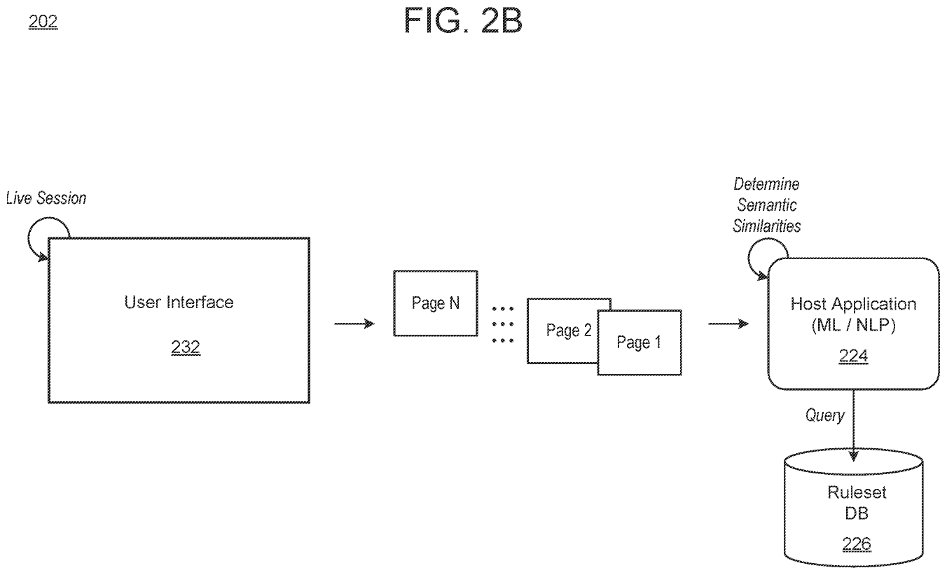

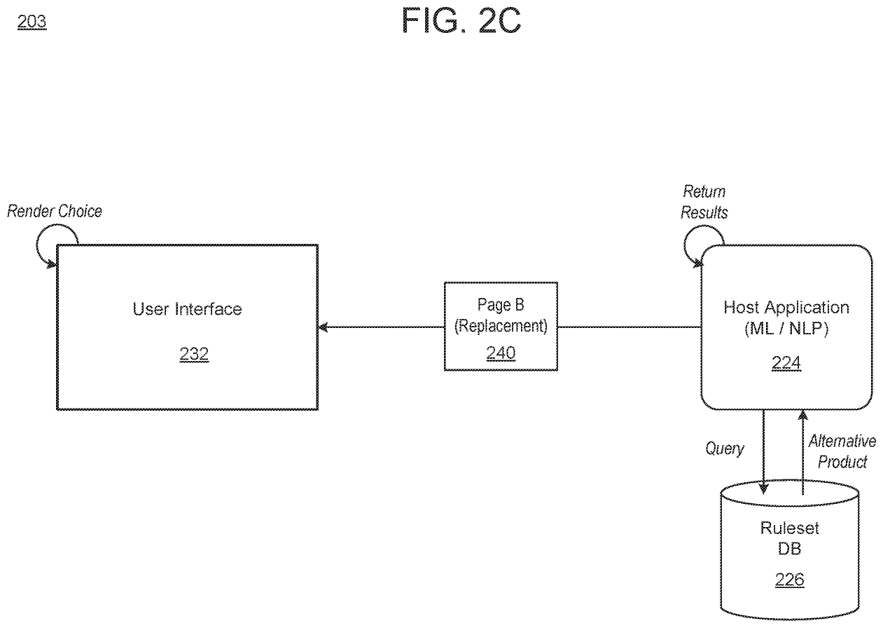

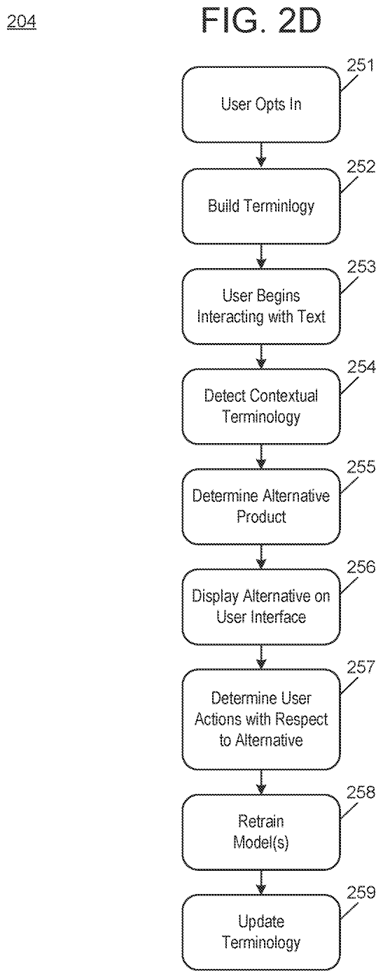

FIGS. 2A-2D are directed to processes that are performed by a host platform 220, such as a cloud platform described in the example of FIG. 1. As an example, the processes performed in FIGS. 2A-2D may be performed by a software application or other program that is hosted on a cloud platform, however, embodiments are not limited thereto. In these examples, the software application can guide a user to identify alternative products/objects in comparison to other objects/products that are currently displayed on a user interface, spoken about during a call (such as a telephonic or video conference, and the like. The software application can provide/display a link to a web page of an alternative product in real-time on the user interface, or a meeting device where the audio is captured. The software application can use the context from data, such as a block of text or an image, that describes or depicts the object to identify an alternative product/object. For example, the data may be input to a machine learning model that can map an identifier such as a name of a product to a name of a commercially alternative product.

For example, the host system may identify specific products in a block of text and provide a user interface replacement with known personal alternatives. As noted, the back-end of the system may reside on a host platform such as a cloud platform or a server. In addition, the back-end system may be connected to a software component on a local user device such as a smartphone, a meeting device, a laptop, a computer, a wireless device, and the like. In this example, the host system may reside on a collaborative meeting device and prompt the listening or attending users when the word and/or product is detected and then display an alternative word and/or product. As another example, the host system may execute a neural network such as a Generative Adversarial Network (GAN) to display functional diagrams and images with familiar brand terminology that is substituted with the alternative product.

In some embodiments, the host system can select a terminology format based on the audience that is to receive the alternative, such as email recipients. For example, the system may generate an electronic message whereby each time a name of the object is listed, the name of the alternative object can be added with parenthesis (or other symbols, markings, characters, etc.), identifying it and then using it to replace the original name of the object within the email. Thus, a more generic email could be used with the object name replaced.

FIG. 2A, illustrates a process 201 of a host platform 220 generating and providing replacement content to a browser (e.g., mobile browser, web browser, etc.) installed on a user device such as a user device 230 or a mobile device 234. For example, a user interface 232 (e.g., a browser, etc.) installed on the user device 230 may be accessed by a user. The user may control the user interface 232 to load a web page, for example, by typing a URL or other identifier into a command line or other interface. In response, the user interface 232 may navigate to the web page, causing a display of the web page to be populated within an area/module on the user interface 232. In response, the browser on the user device 230 may send a natural language input (e.g., text content from the web page, the page itself, etc.) to a communication module 222 on the host platform 220 for analysis of a replacement/alternative object. Upon receiving the natural language input from the browser, the communication module 222 may forward the natural language input to a host application 224.

As shown in process 202 of FIG. 2B, the user interface 232 may track each page that is visited by the user during a live session and send it back to the host application 224 on the host platform. The host application 224 may analyze the text within the natural language input for possible opportunities to provide a replacement/alternative object. As an example, the host application 224 may execute one or more models on text (and/or image) within the web pages and perform a semantic (and/or visual) analysis on the text (and/or image) to identify a target product that can be replaced with an alternative. The analysis may be based on the contextual words around the name of the target product which can be used by the model to identify a similar product (alternative product name) that would fit within the same context/words on the web page. Here, the host application 224 may query a rule set found in a database 226 based on the identified product name to receive one or more names of one or more alternative products. The query may identify the name of the object to be replaced.

In response, the host application 224 may identify an alternative object that is contextually similar to the object displayed in the block of text on the user interface 232. For example, the host application 224 may access a rule set from the database 226. Here, the host application 224 may analyze the block of text via one or more of a machine learning (ML) model, a natural language processing model, an artificial intelligence model, etc., to identify keywords corresponding to product names, and context surrounding such keywords. This text can be used to identify the alternative object.

FIG. 2C illustrates a process 203 of rendering a prompt on the user interface 232 with a link or other selectable option to the web page of the alternative object (e.g., replacement page 240 which includes a listing of the alternative object). Here, a web page, website, etc., associated with the alternative object (e.g., a product sales page, etc.) may be identified from the rule set 226 and sent to the user interface 232 (for example, the browser on the user device 230) as the replacement page 240. The browser may display a prompt, a pop-up (such as a window, a text prompt, an image prompt, etc.), an overlay, etc., with a link (hyperlink, URL, etc.) to the web page of the alternative object on the user interface 232. In some embodiments, the prompt may also include information about the alternative object such as product details, price, availability, etc.

Referring again to FIG. 2A, rather than the natural language input being provided from the user interface 232, as another example, the natural language input may be provided to the communication module 222 from the mobile device 234 such as a cell phone, laptop, mobile device, etc. The input in this case may be in the form of audio that can be converted to text by a speech-to-text converter/audio-to-text converter that is included in the host platform 220 or installed locally on the mobile device 234. Here, the same analysis can be performed to identify an object that may be replaced with an alternative object and a link to the alternative object may be displayed on the mobile device 234, for example, within a prompt inside a mobile browser (or another interface, such as an app) on the mobile device 234.

FIG. 2D illustrates a process 204 of identifying an alternative product and displaying information about the alternative product in real-time (or near real-time) according to example embodiments. The process can be performed in conjunction with any system or component described herein. Referring to FIG. 2D, in 251, a user may use a device to opt into the host application 224 and provide access to their given devices including, but not limited to, mobile browsers, web browsers, etc. In 252, the host application 224 may compile a terminology comparison rule set. Here, the rule set may be pulled from an existing source, assembled manually by an individual or team that is written into a rules table, or the like.

As another example, the terminology alternatively could be assembled by semantic categorization. For example, the semantic categorization component can execute processing of documents at an aggregate level and find cosine similarity and other frequently used words that are associated with each other. The semantic categorization process may utilize information and metadata from consumer sites and other sites for search alternative terms that lead to the same or very similar reference value. In some embodiments, the history of a consumer's search/purchase/view information may be maintained and used to find results and alternatives to be inserted into an artificial intelligence (AI) semantic association module, for example.

In 253, the host system begins monitoring user devices for data such as fuzzy words, terminology, commercial specific terminology, etc., which can be embedded in documents, web pages, audio, video and the like. In some embodiments, the host system may analyze the user's level of expertise and familiarity with the given terminology to determine whether to proceed. In some embodiments, the host system may receive speech/audio and convert the speech to text.

In 254, the host system executes a machine learning model such as a recurrent neural network (RNN) that may be executed via supervised learning to identify specific types of data, such as terms that are commercial and can be replaced by alternative terms/products. For example, the host system may use a weighing algorithm that is executed via supervised learning through document discovery and historical analysis of comparing the commercial term found within the results (which may be viewable) to identify alternative data, such as an object/product in 255. The alternative data may be output to a user interface of a device that captured the web content/audio. For example, the alternative option may be overlayed via a pop-up window, prompt, etc., that shows a link to the alternative option along with details about the alternative option such as product description, price, availability, etc.

A user may confirm or select the alternative proposed by the system enabling the system to learn from its selections. For example, the system may recommend an alternative term/object and provide sources such as web pages for the user to investigate or refer to in 256. Thus, the user then has the opportunity to validate the alternative object by taking an action, such as selecting an element such as a button, a menu item, etc. within the prompt.

In 257, the host system may identify the user's actions with respect to the alternative option displayed on the screen. For terms that are incorrect or for other terms that are fuzzy with a non-confident resultant, the host system may capture the user performing a search action such as right clicking on a term and/or searching it. The module will monitor the user's investigation pathway and find the alternative along with any search terms used by the individual until they find their desired target term. The user investigation pathway may be captured based on a combination of metrics involving active and non-active windows and start and stop points of browser tabs along with metadata from the page. Process mining and/or task mining can be performed at this step to help assist with pathway retrieval. In 258, the host system may retrain the RNN based on any feedback, corrections, or confirmations from the user based primarily on word replacements or alternatives in the execution of the steps. The host system may also update the terminology with any newly matched alternatives in 259. Whether the user visits the link/option in the prompt may be detected and used to train the model as an example of a successful option. These corpuses may maintain a relationship private to the individual or in some embodiments may be used for a larger group or global corpus.

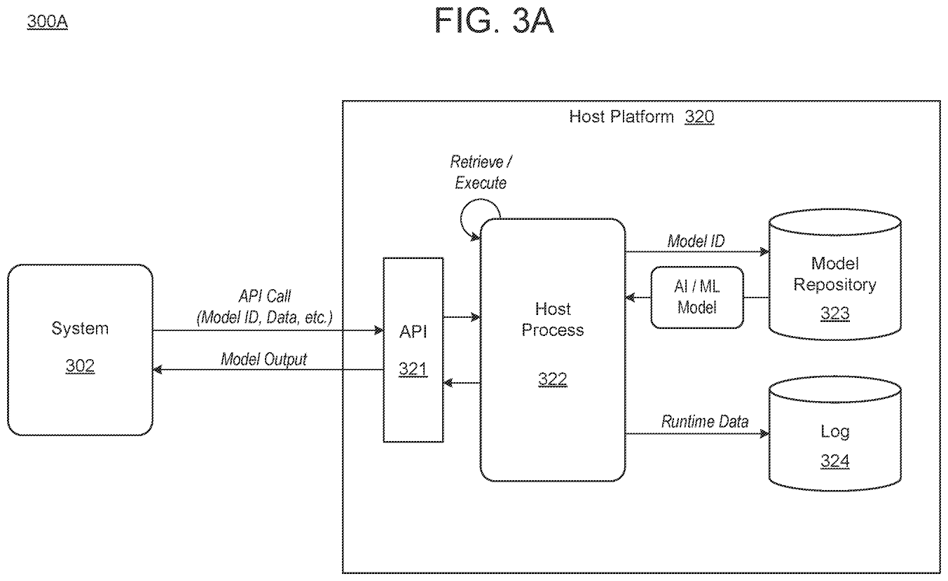

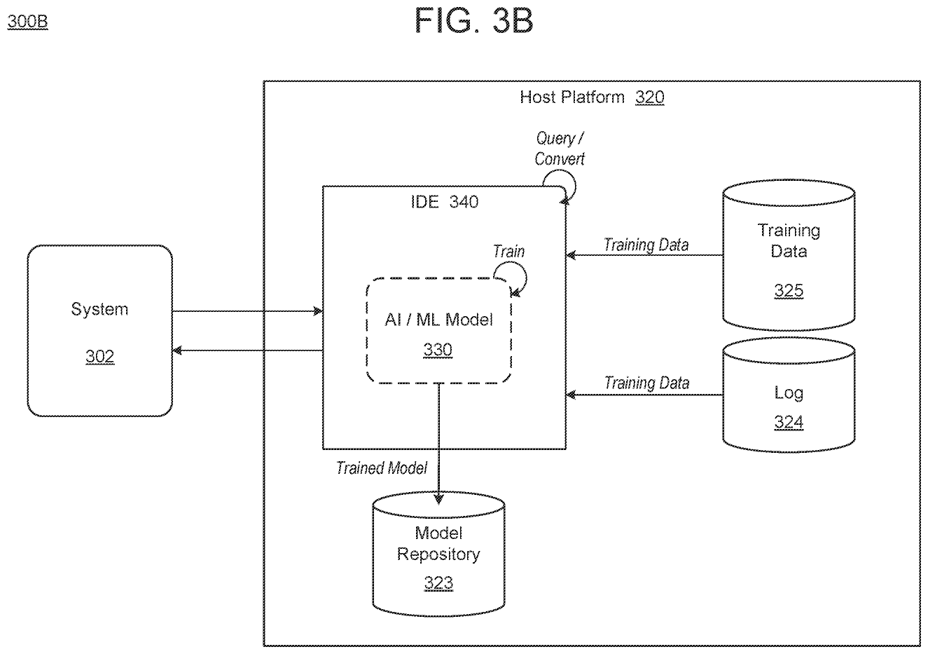

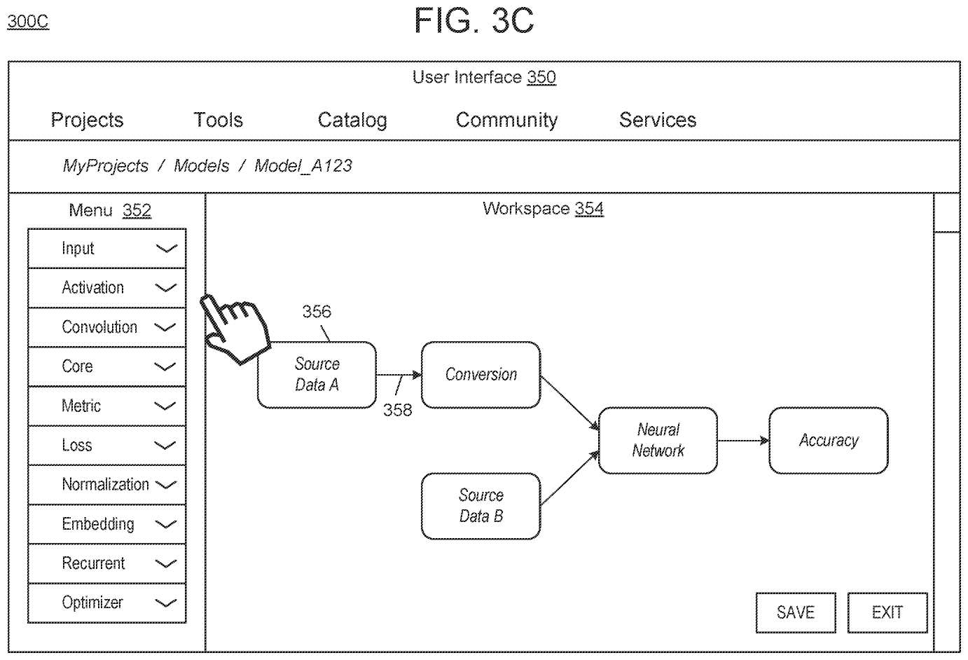

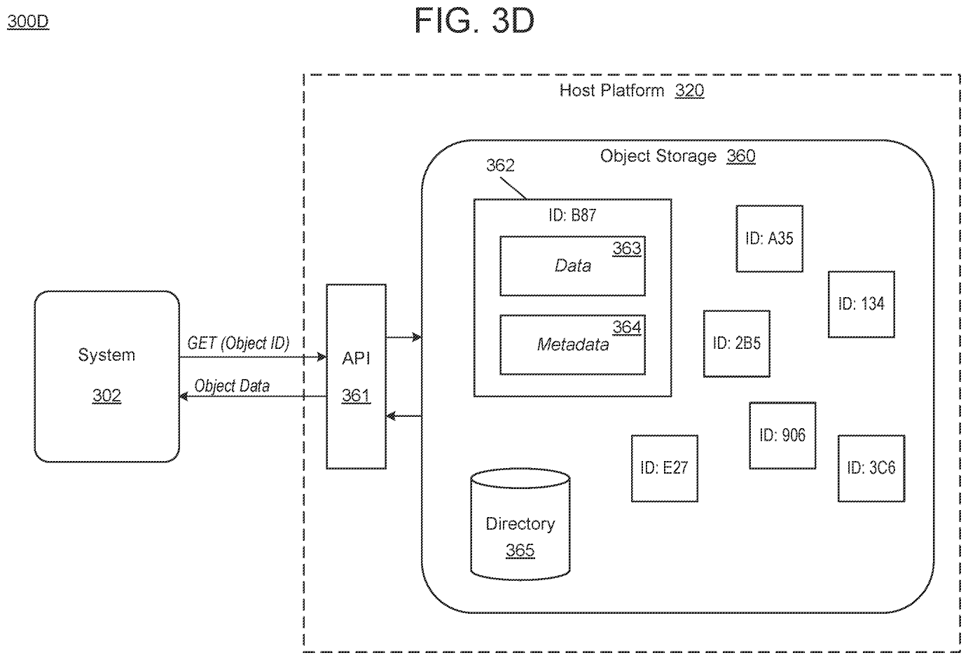

The example embodiments may communicate with a host platform 320 as shown in the examples of FIGS. 3A-3D. For example, a system 302 may contain the logic for performing the methods and processes described herein including the host application 224 that may include one or more machine learning models, artificial intelligence models, natural language processing models, etc. The models used by the host application 224 may be trained and executed as further described herein. The models may be integrated/built-into the host application 224 or they may be externally called/accessed by the host application 224. The system 302 may be hosted by or otherwise communicate with the host platform 320 shown in FIGS. 3A, 3B and 3D. Further, the methods, systems, and processes described herein may interact with the processes and systems that are described in FIGS. 3A-3D.

FIG. 3A illustrates a process 300A of executing a machine learning model via the host platform 320. As an example, the machine learning model may refer to a machine learning model that can map a name of an object (e.g., a product) to a name of a similar object (e.g., a similar product) based on context of the page, word, speech, etc. The host platform 320 may host a host process 322 within a live runtime environment that is accessible to other software programs, applications, and the like, via a network such as the Internet. Here, the host process 322 may have a URL, endpoint, API, etc. which is publicly available on the Internet.

In this example, the host process 322 may control access to and execution of models that are stored within a model repository 323. For example, the models may include AI models, machine learning models, neural networks, or the like. The system 302 may trigger execution of a model from the model repository 323 via submission of a call to an application programming interface (API) 321 of the host process 322. The request may include an identifier of a model or models to be executed, a payload of data (e.g., to be input to the model during execution), and the like. The host process 322 may receive the call from the system 302 and retrieve the corresponding model from the model repository 323, deploy the model within a live runtime environment, execute the model on the input data, and return a result of the execution to the system 302. The result of the execution may include an output result from the execution of the model.

In some embodiments, the system 302 may provide feedback from the output provided by the model. For example, a user may input a confirmation that the prediction output by the model is correct or provide notification that the model is incorrect. This information may be added to the results of execution and stored within a log 324. The log data may include an identifier of the input, an identifier of the output, an identifier of the model used, and feedback from the recipient. This information may be used to subsequently re-train the model, for example, using the model development environment shown in the example of FIG. 3B.

In other embodiments, the system 302 may perform one or more of receiving a natural language input submitted from a user device (not shown), identifying a name of an object based on the natural language input, mapping the name of the object to a name of an alternative object, and identifying a web page corresponding to the alternative object via a rule set, and displaying an option to navigate to the identified web page corresponding to the alternative object via a user interface displayed on the user device.

FIG. 3B illustrates a process 300B of training a machine learning model 330 according to example embodiments. Referring to FIG. 3B, the host platform 320 may host an integrated development environment (IDE) 340 where machine learning models, AI models, and the like may be developed, trained, retrained, and the like. In this example, the IDE 340 may include a software application with a user interface accessible by the system 302. For example, the IDE 340 may be embodied as a web application that can be accessed by a device at a network address, URL, etc. As another example, the IDE 340 may be locally or remotely installed on a computing device used by a user.

The system 302 may be used to design a model (via a user interface of the IDE), such as a machine learning model, etc. The model can then be executed/trained based on the training data established via the user interface. For example, the user interface may be used to build a new model. The training data for training such a new model may be provided from a training data store 325, which includes training samples from the web, from customers, and the like. Here, the model is executed on the training data via the host platform 320 to generate a result. The execution of the model causes the model to learn based on the input training data. When the model is fully trained, it may be stored within the model repository 323 via the IDE 340, or the like.

As another example, the IDE 340 may be used to retrain an existing model. Here, the training process may use executional results previously generated/output by the machine learning model 330 (including any feedback, etc.) to retrain the machine learning model 330. For example, predicted outputs that are identified as accurate, best, good, etc., may be distinguished from outputs that are inaccurate, incorrect, bad, etc. One or more of these types of outputs can be identified and used for retraining the model to help the model provide better outputs.

As a further example, the system 302 can map the identifying name of the object based on the natural language input, name of the object to the name of the alternative object via execution of the machine learning model 330 on the natural language input. The system 302 can detect whether the user selects the option to navigate to the identified web page that corresponds to the alternative object and retrain the machine learning model 330 based on the detected user selection and the alternative object.

FIG. 3C illustrates a process 300C of designing a new machine learning model via a user interface of the system 302 according to example embodiments. As an example, the system 302 may be output as part of the software application which interacts with the IDE 340 shown in FIG. 3B, however, embodiments are not limited thereto. Referring to FIG. 3C, a user can use an input mechanism to make selections from a menu 352 of a user interface 350 to add pieces/components to a model being developed within a workspace 354 of the user interface 350.

In the example of FIG. 3C, the menu 352 includes a plurality of graphical user interface (GUI) menu options which can be selected to access or drill-down into additional components that can be added into the model design shown in the workspace 354. Here, the GUI menu includes options for adding features such as neural networks, machine learning models, AI models, data sources, conversion processes (e.g., vectorization, encoding, etc.), analytics, etc. The user can continue to add features to the model and connect them using edges or other means to create a flow within the workspace 354. For example, the user may add a node 356 to a diagram of a new model within the workspace 354. For example, the user may connect the node 356 to another node in the diagram via an edge 358, creating a dependency within the diagram. When the user is done, the user can save the model for subsequent training/testing.

In another example, the name of the object can be identified from a web page or a user interface 350 where the object is visible within a browser or the workspace 354 on the user device. A pop-up within the browser or the workspace 354 can be overlayed where the object is visible, which includes an option to navigate to the identified web page corresponding to the alternative object via the rule set.

FIG. 3D illustrates a process 300D of accessing an object 362 from an object storage 360 of the host platform 320 according to example embodiments. For example, the object storage 360 may store data that is used by the AI models and machine learning (ML) models 224, 330, training data, expected outputs for testing, training results, and the like. The object storage 360 may also store any other kind of data. Each object may include a unique identifier, a data section 363, and a metadata section 364 which provides for descriptive context associated with the data, including data that can later be extracted for purposes of machine learning. The unique identifier may uniquely identify an object with respect to all other objects in the object storage 360. The data section 363 may include unstructured data such as web pages, digital content, images, audio, text, and the like.

Instead of breaking files into blocks stored on disks in a file system, the object storage 360 handles objects as discrete units of data stored in a structurally flat data environment. Here, the object storage may not use folders, directories, or complex hierarchies. Instead, each object may be a simple, self-contained repository that includes the data, the metadata, and the unique identifier that the system 302 can use to locate and access it. In this case, the metadata is more descriptive than with a file-based approach. The metadata can be customized with additional context that can later be extracted and leveraged for other purposes, such as data analytics.

The objects that are stored in the object storage 360 may be accessed via an API 361. The API 361 may be a Hypertext Transfer Protocol (HTTP)-based RESTful API (also known as a RESTful Web service). The API 361 can be used by the system 302 to query an object's metadata to locate the desired object (data) via the Internet from anywhere, on any device. The API 361 may use HTTP commands such as “PUT” or “POST” to upload an object, “GET” to retrieve an object, “DELETE” to remove an object, and the like.

The object storage 360 may provide a directory 365 that uses the metadata of the objects to locate appropriate data files. The directory 365 may contain descriptive information about each object stored in the object storage 360, such as a name, a unique identifier, creation time stamp, collection name, etc. To query the object within the object storage 360, the system 302 may submit a command, such as an HTTP command, with an identifier of the object 362, a payload, etc. The object storage 360 can store the name of the object as well as the name of the alternative object the name of the object is mapped to. The identity of the web page corresponding to the alternative object, as well as the rule set, can also be stored in the object storage 360.

For example, the system 302 may query the object storage 360 via the API 361 with a predefined command to retrieve data from the object storage 360. Here, the query may comprise an identifier of an object from among the objects stored in the object storage 360. The object storage 360 may process the query and return object data from a corresponding object that matches the identifier within the object storage 360. The data may include customer data, personal data, code, model training data, models themselves, or the like.

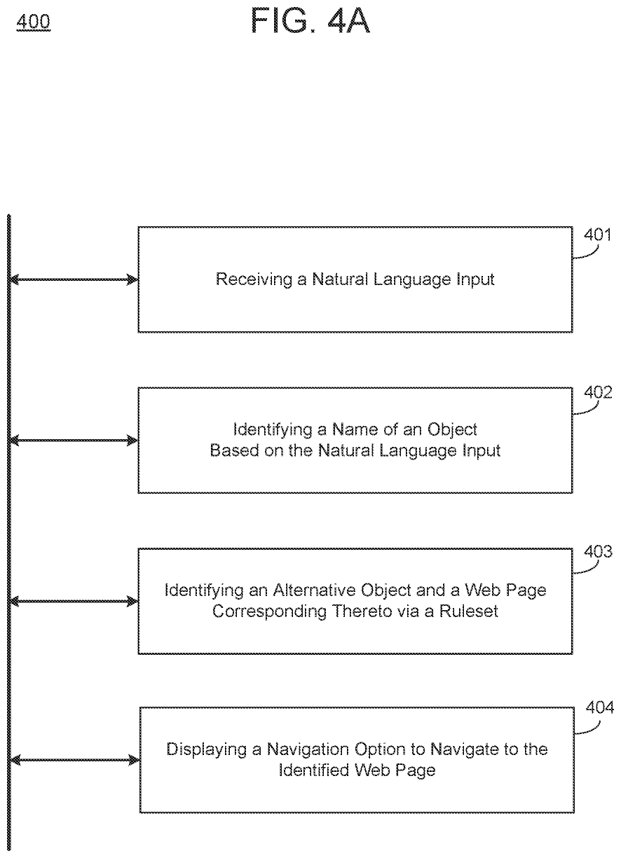

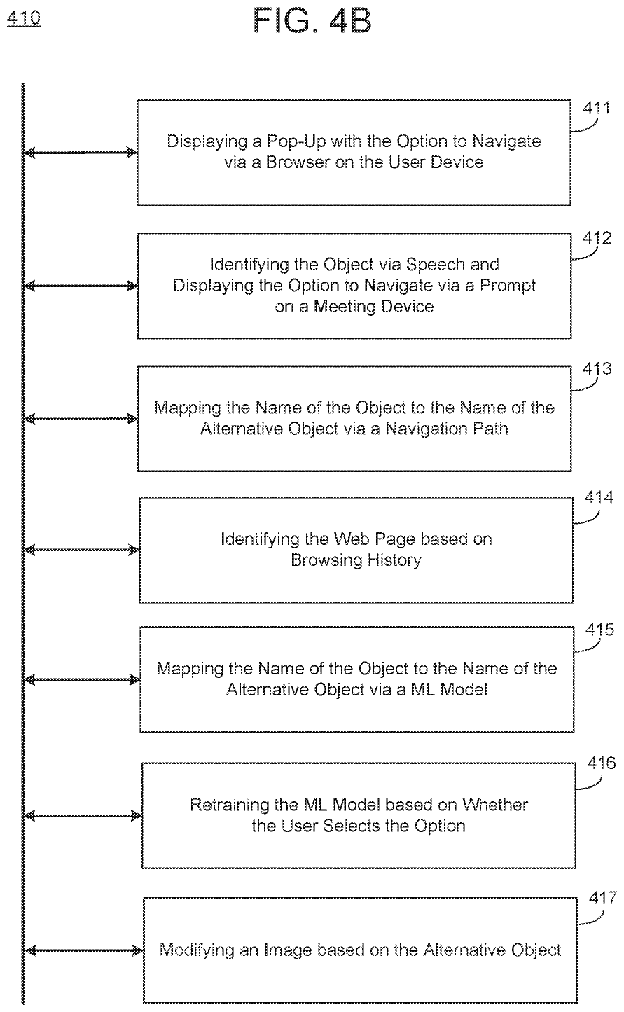

FIG. 4A illustrates a method 400 of generating and displaying an option for alternative content according to example embodiments, and FIG. 4B illustrates a method 410 of generating and displaying an option for alternative content according to other example embodiments. Referring to FIG. 4A, in 401, the method may include receiving a natural language input submitted from a meeting device. In 402, the method may include identifying a name of an object based on the natural language input. In 403, the method may include mapping the name of the object to a name of an alternative object and identifying a web page corresponding to the alternative object via a rule set. In 404, the method may include displaying an option to navigate to the identified web page corresponding to the alternative object via a user interface displayed on the user device.

Referring now to FIG. 4B, in 411, the method may include identifying the name of the object from a web page where the object is being viewed within a browser on the user device, and the displaying may include overlaying a pop-up within the browser where the object is being displayed which includes the option to navigate to the identified web page. In 412, the identifying may include identifying the name of the object from speech that is received from speech that is received from a meeting device (for example, a device associated with a teleconference), and the displaying comprises displaying a prompt via the meeting device, which includes the option to navigate to the identified web page. In 413, the mapping may include generating a navigation path based on the natural language input submitted from the user device and mapping the name of the object to the name of the alternative object based on the navigation path.

In 414, the method may further include receiving browsing history from a browser on the user device, and the identifying comprises identifying the web page corresponding to the alternative object based on the browsing history. In 415, the mapping of the name of the object to the name of the alternative object may include executing a machine learning model on the natural language input to perform the mapping. In 416, the method may further include detecting whether the user selects the option to navigate to the identified web page corresponding to the alternative object and retraining the machine learning model based on the detection. In 417, the identifying may include identifying an image included in the natural language input and modifying the image to generate a new image based on the alternative object.

The above embodiments may be implemented in hardware, in a computer program executed by a processor, in firmware, or in a combination of the above. A computer program may be embodied on a computer readable medium, such as a storage medium. For example, a computer program may reside in random access memory (“RAM”), flash memory, read-only memory (“ROM”), erasable programmable read-only memory (“EPROM”), electrically erasable programmable read-only memory (“EEPROM”), registers, hard disk, a removable disk, a compact disk read-only memory (“CD-ROM”), or any other form of storage medium known in the art.

Although an exemplary embodiment of at least one of a system, method, and computer readable medium has been illustrated in the accompanying drawings and described in the foregoing detailed description, it will be understood that the application is not limited to the embodiments disclosed but is capable of numerous rearrangements, modifications, and substitutions as set forth and defined by the following claims. For example, the system's capabilities of the various figures can be performed by one or more of the modules or components described herein or in a distributed architecture and may include a transmitter, receiver, or pair of both. For example, all or part of the functionality performed by the individual modules may be performed by one or more of these modules. Further, the functionality described herein may be performed at various times and in relation to various events, internal or external to the modules or components. Also, the information sent between various modules can be sent between the modules via at least one of: a data network, the Internet, a voice network, an Internet Protocol network, a wireless device, a wired device and/or via a plurality of protocols. Also, the messages sent or received by any of the modules may be sent or received directly and/or via one or more of the other modules.

One skilled in the art will appreciate that a “system” could be embodied as a personal computer, a server, a console, a personal digital assistant (PDA), a cell phone, a tablet computing device, a smartphone, or any other suitable computing device, or combination of devices. Presenting the above-described functions as being performed by a “system” is not intended to limit the scope of the present application in any way but is intended to provide one example of many embodiments. Indeed, methods, systems, and apparatuses disclosed herein may be implemented in localized and distributed forms consistent with computing technology.

It should be noted that some of the system features described in this specification have been presented as modules in order to more particularly emphasize their implementation independence. For example, a module may be implemented as a hardware circuit comprising custom, very large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, comprise one or more physical or logical blocks of computer instructions that may, for instance, be organized as an object, procedure, or function. Nevertheless, the executables of an identified module need not be physically located together but may comprise disparate instructions stored in different locations, which, when joined logically together, comprise the module and achieve the stated purpose for the module. Further, modules may be stored on a computer-readable medium, which may be, for instance, a hard disk drive, flash device, random access memory (RAM), tape, or any other such medium used to store data.

Indeed, a module of executable code could be a single instruction or many instructions and may even be distributed over several different code segments, among different programs, and across several memory devices. Similarly, operational data may be identified and illustrated herein within modules and may be embodied in any suitable form and organized within any suitable type of data structure. The operational data may be collected as a single data set or may be distributed over different locations, including over different storage devices, and may exist, at least partially, merely as electronic signals on a system or network.

It will be readily understood that the components of the application, as generally described and illustrated in the figures herein, may be arranged and designed in a wide variety of different configurations. Thus, the detailed description of the embodiments is not intended to limit the scope of the application as claimed but is merely representative of selected embodiments of the application.

One having ordinary skill in the art will readily understand that the above may be practiced with steps in a different order and/or with hardware elements in configurations that are different from those which are disclosed. Therefore, although the application has been described based upon these preferred embodiments, it would be apparent to those of skill in the art that certain modifications, variations, and alternative constructions would be apparent.

While preferred embodiments of the present application have been described, it is to be understood that the embodiments described are illustrative only, and the scope of the application is to be defined solely by the appended claims when considered with a full range of equivalents and modifications (e.g., protocols, hardware devices, software platforms, etc.) thereto.

What is claimed is:

1. An apparatus comprising:
a processor configured to
receive a natural language input submitted from a user device,
identify a name of an object based on the natural language input,
map the name of the object to a name of an alternative object and identify a web page corresponding to the alternative object, via a rule set, and
display an option to navigate to the identified web page that corresponds to the alternative object via a user interface displayed on the user device.

2. The apparatus of claim 1, wherein the processor is configured to
identify the name of the object from a web page where the object is visible within a browser on the user device, and
overlay a pop-up window within the browser where the object is visible which includes the option to navigate to the identified web page.

3. The apparatus of claim 1, wherein the processor is configured to
identify the name of the object from speech that is received from a meeting device of a teleconference, and
display a prompt via the meeting device which includes the option to navigate to the identified web page.

4. The apparatus of claim 1, wherein the processor configured is configured to
generate a navigation path based on web text on web pages included in the natural language input submitted from the user device, and
map the name of the object to the name of the alternative object based on the navigation path.

5. The apparatus of claim 1, wherein the processor is further configured to
receive browsing history from a browser on the user device, and
further identify the web page that corresponds to the alternative object based on the browsing history.

6. The apparatus of claim 1, wherein the processor is configured to map the name of the object to the name of the alternative object via execution of a machine learning model on the natural language input.

7. The apparatus of claim 6, wherein the processor is further configured to
detect whether the user selects the option to navigate to the identified web page that corresponds to the alternative object, and
retrain the machine learning model based on the detected user selection and the alternative object.

8. The apparatus of claim 1, wherein the processor is configured to identify an image included in the natural language input and modify the image to generate a new image based on the alternative object.

9. A method comprising:
receiving a natural language input submitted from a user device;
identifying a name of an object based on the natural language input;
mapping the name of the object to a name of an alternative object and identifying a web page corresponding to the alternative object, via a rule set; and
displaying an option to navigate to the identified web page corresponding to the alternative object via a user interface displayed on the user device.

10. The method of claim 9, wherein the identifying comprises identifying the name of the object from a web page where the object is being viewed within a browser on the user device, and the displaying comprises overlaying a pop-up window within the browser where the object is being displayed which includes the option to navigate to the identified web page.

11. The method of claim 9, wherein the identifying comprises identifying the name of the object from speech that is received from speech that is received from a meeting device of a teleconference, and the displaying comprises displaying a prompt via the meeting device which includes the option to navigate to the identified web page.

12. The method of claim 9, wherein the mapping comprises generating a navigation path based on web text on web pages included in the natural language input submitted from the user device, and mapping the name of the object to the name of the alternative object based on the navigation path.

13. The method of claim 9, wherein the method further comprises receiving browsing history from a browser on the user device, and the identifying comprises identifying the web page corresponding to the alternative object based on the browsing history.

14. The method of claim 9, wherein the mapping the name of the object to the name of the alternative object is performed via execution of a machine learning model on the natural language input.

15. The method of claim 14, wherein the method further comprises detecting whether the user selects the option to navigate to the identified web page corresponding to the alternative object, and retraining the machine learning model based on the detection.

16. The method of claim 9, wherein the identifying comprises identifying an image included in the natural language input and modifying the image to generate a new image based on the alternative object.

17. A computer program product comprising a computer readable storage medium having stored thereon instructions, that when executed by a processor, cause the processor to perform:
receiving a natural language input submitted from a user device;
identifying a name of an object based on the natural language input;
mapping the name of the object to a name of an alternative object and identifying a web page corresponding to the alternative object, via a rule set; and
displaying an option to navigate to the identified web page corresponding to the alternative object via a user interface displayed on the user device.

18. The computer program product of claim 17, wherein the identifying comprises identifying the name of the object from a web page where the object is being viewed within a browser on the user device, and the displaying comprises overlaying a pop-up window within the browser where the object is being displayed which includes the option to navigate to the identified web page.

19. The computer program product of claim 17, wherein the identifying comprises identifying the name of the object from speech that is received from speech that is received from a meeting device of a teleconference, and the displaying comprises displaying a prompt via the meeting device which includes the option to navigate to the identified web page.

20. The computer program product of claim 17, wherein the mapping comprises generating a navigation path based on web text on web pages included in the natural language input submitted from the user device and mapping the name of the object to the name of the alternative object based on the navigation path.
